(19) United States
(12) Patent Application Publication
(10) Pub. No.: US 2013/0047124 A1
(43) Pub. Date: Feb. 21, 2013

(54) Menu System

(71) Applicants: Henry John Holland, London (GB); Andreea Ligia Chelaru, Amsterdam (NL); Greg Mark Edwards, London (GB); Timothy Laurence Brooke, London (GB)

(72) Inventors: Henry John Holland, London (GB); Andreea Ligia Chelaru, Amsterdam (NL); Greg Mark Edwards, London (GB); Timothy Laurence Brooke, London (GB)

(21) Appl. No.: 13/580,427

(22) PCT Filed: Feb. 23, 2010
(86) PCT No.: PCT/IB2010/050793

§ 371 Date: Oct. 31, 2012

(51) Int. Cl. G06F 3/048

(52) U.S. Cl. 715/835

(57) ABSTRACT

A method including enabling user selection of an image for display as a root screen of a menu system; enabling user definition of a first area in the image that becomes a first actuation-sensitive area of the root screen of the menu system when the image is displayed as the root screen of the menu system; enabling user definition of an association between the first area in the image and a user selected first asset, wherein the association provides for the automatic use of the associated first asset when the first actuation-sensitive area of the root screen of the menu system is actuated while the image is displayed as the root screen of the menu system.

### FIELD OF THE INVENTION

Embodiments of the present invention relate to a menu system and associated methods, apparatus, computer programs and data structures.

### BACKGROUND TO THE INVENTION

Menu systems are commonly used in electronic devices. Graphical menu systems are commonly used in electronic devices that have a display. An end-user is typically able to navigate through the menu by selecting choices at defined waypoints. The choices at a waypoint in a graphical menu system may be presented as separate user actuable widgets such as graphical icons or active portions of a touch-sensitive screen. The waypoints may, for example, be considered as nodes in a graph and the choices may be considered edges of the graph.

It can be a complex and daunting task to create a menu system.

### BRIEF DESCRIPTION OF VARIOUS EMBODIMENTS OF THE INVENTION

According to various, but not necessarily all, embodiments of the invention there is provided a method comprising: enabling user selection of an image for display as a root screen of a menu system; enabling user definition of a first area in the image that becomes a first actuation-sensitive area of the root screen of the menu system when the image is displayed as the root screen of the menu system; enabling user definition of an association between the first area in the image and a user selected first asset, wherein the association provides for the automatic use of the associated first asset when the first actuation-sensitive area of the root screen of the menu system is actuated while the image is displayed as the root screen of the menu system.

According to various, but not necessarily all, embodiments of the invention there is provided an apparatus comprising: means for enabling user selection of an image for display as a root screen of a menu system; means for enabling user definition of a first area in the image that becomes a first actuation-sensitive area of the root screen of the menu system when the image is displayed as the root screen of the menu system; and means for enabling user definition of an association between the first area in the image and a user selected first asset, wherein the association provides for the automatic use of the associated first asset when the first actuation-sensitive area of the root screen of the menu system is actuated while the image is displayed as the root screen of the menu system.

According to various, but not necessarily all, embodiments of the invention there is provided an apparatus comprising: at least one processor and at least one memory including computer program code the at least one memory and the computer program code configured to, with the at least one processor, cause the apparatus at least to perform: enabling user selection of an image for display as a root screen of a menu system; enabling user definition of a first area in the image that becomes a first actuation-sensitive area of the root screen of the menu system when the image is displayed as the root screen of the menu system; enabling user definition of an association between the first area in the image and a user selected first asset, wherein the association provides for the automatic use of the associated first asset when the first actuation-sensitive area of the root screen of the menu system is actuated while the image is displayed as the root screen of the menu system.

According to various, but not necessarily all, embodiments of the invention there is provided a graphical user interface comprising: means for making a user selection action; means for making a user movement action; means for making a user de-selection action; means for enabling user selection of an image for display as a root screen of a menu system; means for enabling user definition of a first area in the image that becomes a first actuation-sensitive area of a root screen of a menu system when the image is displayed as the root screen of the menu system by recognizing, the series of, a user selection action that selects a point in the image, a user movement action relative to the point, and a user de-selection action, wherein the point determines a location of the first area and the user movement action until the user de-selection action determines a boundary of the first area; and means for enabling user definition of an association between the first area in the image and a user selected first asset, wherein the association provides for the automatic use of the associated first asset when the first actuation-sensitive area of the root screen of the menu system is actuated while the image is displayed as the root screen of the menu system.

According to various, but not necessarily all, embodiments of the invention there is provided an apparatus comprising: at least one processor and at least one memory including computer program code and a collection of data structures, the at least one memory and the computer program code configured to, with the at least one processor, cause the apparatus at least to provide a menu system arranged as a directed acyclic tree graph comprising nodes and edges wherein the menu is navigable by defining a single active node that represents the current menu state of the menu system and wherein navigating from one state of the menu system to another state of the menu system involves moving the allocation of the active node from a current node to another node directly interconnected by an edge to the current node, wherein the collection of data structures comprises: a nodular data structure for each internal node comprising:
a definition of an asset used when the internal node is the active node,
a definition of one or more user actuable widgets when the internal node is the active node and
a definition for each user actuable widget of an identifier identifying an associated nodular data structure; and
a nodular data structure for each leaf node comprising:

a definition of an asset used when the leaf node is the active node,
wherein the apparatus initially provides the menu system by reading the nodular data structure representing the root node of the directed acyclic tree graph.

### BRIEF DESCRIPTION OF THE DRAWINGS

For a better understanding of various examples of embodiments of the present invention reference will now be made by way of example only to the accompanying drawings in which:

FIG. 1 schematically illustrates a method of creating a navigable graphical menu system;

FIGS. 2A to 2G schematically illustrate the use of a graphical user interface (GUI) in creating a navigable graphical menu system;

FIGS. 3A and 3B schematically illustrate alternative implementations of touch-sensitive areas in a root screen of a menu system;

FIG. 4 schematically illustrates an apparatus suitable for use in performing the method described with reference to FIG. 1 and other Figures;

FIG. 5 schematically illustrates a collection of nodular data structures;

FIG. 6 schematically illustrates an example of a directed acyclic rooted tree graph; and

FIGS. 7A and 7B schematically illustrate the use of different assets associated with different nodes of the graph, where the assets are images for screens of a menu system and have touch-sensitive areas for navigating the menu system.

### DETAILED DESCRIPTION OF VARIOUS EMBODIMENTS OF THE INVENTION

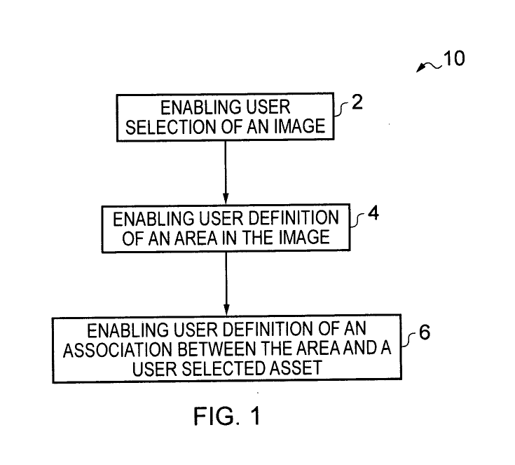

FIG. 1 schematically illustrates a method 10 of creating a navigable graphical menu system. The method comprises: at block 2, enabling user selection of an image for display as a root screen of a menu system; at block 4, enabling user definition of a first area in the image that becomes a first actuation-sensitive area of the root screen of the menu system when the image is displayed as the root screen of the menu system; and at block 6, enabling user definition of an association between the first area in the image and a user selected first asset, wherein the association provides for the automatic use of the associated first asset when the first actuation-sensitive area of the root screen of the menu system is actuated while the image is displayed as the root screen of the menu system.

In the following description reference will be made to ‘use’ and ‘user’. A user may be a person who creates a menu system whether by manufacture or adaptation. A user may alternatively be a person who uses the created menu system. It will be apparent from context which user is referred to.

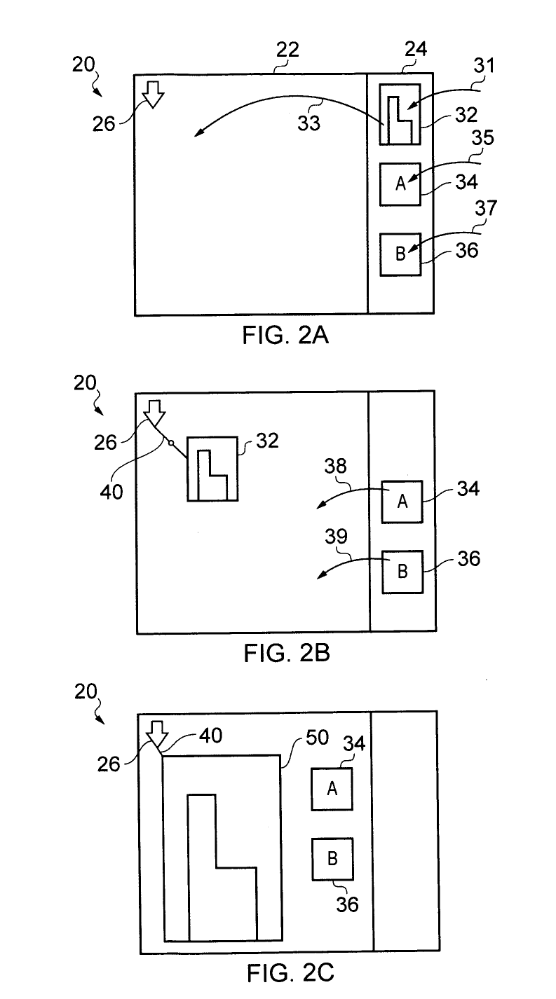

One example of the method 10 of creating a navigable graphical menu system is illustrated with reference to FIGS. 2A to 2G. In this example, there is illustrated a method of creating a navigable touch-screen menu system for end use in a touch screen device.

The FIGS. 2A to 2G schematically illustrate a graphical user interface (GUI) 20 that is configured to enable the manufacture of a touch-screen navigable menu system. The GUI 20 is configured to detect and discriminate a user selection action, a user movement action and a user de-selection action.

FIG. 2A schematically illustrates how the GUI 20 is configured to enable user selection of an image 32 for display as a root screen of a menu system.

The GUI 20 comprises a work area 22 and a storage area 24.

The GUI 20 enables an asset to be dragged and dropped into the storage area 24. For example, a graphical representation 32 of an image 50 may be dragged and dropped 31 into the storage area 24. A graphical representation 34 of an asset A may be dragged and dropped 35 into the storage area 24. A graphical representation 36 of an asset B may be dragged and dropped 37 into the storage area 24. An asset may be, for example, a media asset such as an image or a video or an animation or it may be an executable asset such as an application or an executable file etc.

The GUI 20 is configured to enable user selection of the image 50 by recognizing, in series, a user selection action that selects the graphical representation 32 of the image 50, a user movement action 33 that drags the graphical representation 32 of the image 50 from the storage area 24 to a user defined position within the work area 22, and a user de-selection action that drops the graphical representation 32 of the image 50 at that location. For example, a mouse or other cursor control device may be used to select the graphical representation 32 of the image 50 from the storage area 24 and to drag and drop it at a user defined position within the work area 22. Alternatively, in a touch-screen implementation, a finger may be touched against the touch screen at the graphical representation 32 of the image 50 to select it. Tracing the finger across the touch-screen from the storage area 24 to the user defined position within the work area 22 and removing the finger, drops the graphical representation 32 of the image 50 at the user defined position within the work area 22.

As illustrated in FIG. 2B, the GUI 20 is configured to create a link 40 from a fixed starting point 26 to the graphical representation 32 of the image 50 in the work area 22.

Referring to FIG. 2B, the GUI 20 is configured to enable user selection of a first asset A by recognizing, in series, a user selection action that selects a graphical representation 34 of the first asset A, a user movement action 38 that drags the graphical representation 34 of the first asset A to a user-defined position within the work area 22, and a user de-selection action that drops the graphical representation 34 of the first asset A at that user-defined location.

The GUI 20 is also configured to enable user selection of a additional assets by recognizing, in series, a user selection action that selects a graphical representation 36 of the additional asset B, a user movement action 39 that drags the graphical representation 36 of the additional asset B to a user-defined position within the work area 22, and a user de-selection action that drops the graphical representation 38 of the additional asset B at that user-defined location.

Referring to FIG. 2C, the GUI 20 is configured to enable a user to convert the graphical representation 32 of the first image into a display of the first image 50 within the work area 22. This may, for example, occur in response to a double actuation of the graphical representation 32 of the first image, for example, by double-clicking using a mouse or double tapping on a touch-screen.

As illustrated in FIG. 2D, the GUI 20 is configured to enable user definition of a first area 52 in the image 50. GUI is configured to recognize, in series, a user selection action that selects a point 54 in the image 50, a user movement action 53 relative to the point 52, and a user de-selection action. The point 54 determines a location of the first area 52 and the user movement action 53 until the user de-selection action determines a boundary 56 of the first area 52. For example, in one implementation the user selects a start point 54, performs a drag and drop action to an end point, where the distance between the start point 54 and the end point defines a dimension of a predetermined shape such as a diagonal of a rectangle or a diameter of a circle. The shape defines the first area 52. For example, in another implementation the user selects a start point 54, performs a tracing action to return to the start point 54, where the trace forms a boundary of the first area 52.

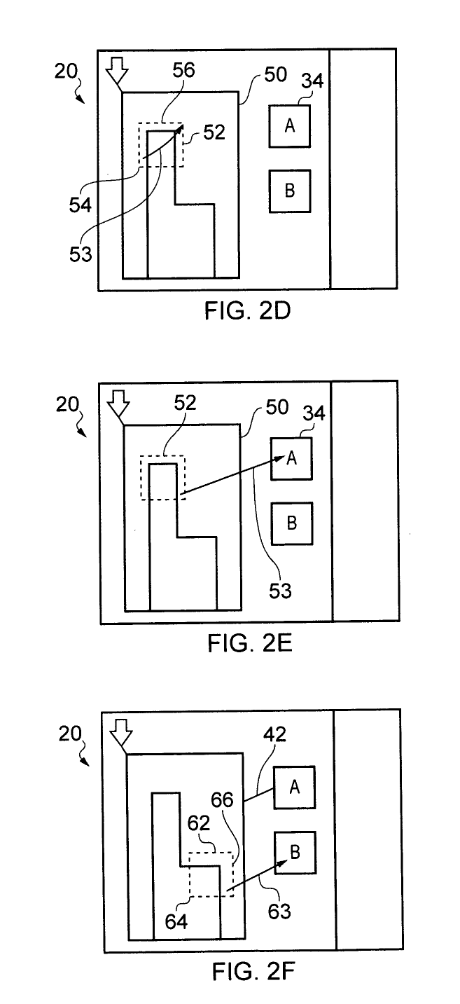

Referring to FIGS. 3A and 3B, the first area 52 becomes a first touch-sensitive area 72 of the root screen 76 of the menu system when the image 50 is displayed as the root screen 76 of the menu system on a touch-screen device 70.

In FIG. 3A, the first touch sensitive area 72 is not highlighted or demarcated in the image 50. In FIG. 3B, the first touch sensitive area 72 is highlighted 78 or otherwise demarcated in the image 50.

Referring back to FIG. 2D, as part of the process of defining the first area 52, the GUI 20 may also enable a user to define visual attributes of the first area 52. The visual attributes may, for example, be permanent highlighting that highlights the presence and location of the first touch sensitive area 72 corresponding to the first area 52. The highlighting may, for example, be achieved by filtering the first area 52 of the image 50, for example, to affect its apparent transparency, to affect its apparent translucency, to delineate its boundary, etc

Referring to FIG. 2E, the GUI 20 is configured to enable user definition of an association between the first area 52 in the image 50 and a user selected first asset. GUI 20 is configured to recognize, in series, a user selection action that selects the first area 52, a user movement action 53 between the first area 52 and the graphical representation 34 of the first asset A, and a user de-selection action at the graphical representation 34 of the first asset A. This series of actions creates an association between the first area 52 in the image 50 and the user selected first asset A.

The association between the first area 52 in the image 50 and the user selected first asset is represented graphically by a visible first graphical link 42 between the image 50 (and subsequently the graphical representation 32 of the image 50) and the graphical representation 34 of first asset A.

Referring to FIGS. 3A and 3B, this association provides for the automatic use by the touch screen device 70 of the associated first asset A when the first touch-sensitive area 72 of the root screen 76 of the menu system is actuated while the image 50 is displayed as the root screen 76 of the menu system.

Referring to FIG. 2F, the GUI 20 is configured to enable user definition of multiple additional areas in the image 50 that become multiple additional touch-sensitive areas 74 of the root screen 76 of the menu system when the image 50 is displayed as the root screen 76 of the menu system by the touch-sensitive device 70. The GUI 20 is also configured to enable user definition of an association between each respective additional area 62 in the image 50 and a respective user selected asset B. The association provides for the automatic use of the associated asset B when the respective touch-sensitive area 74 of the root screen 76 of the menu system is actuated while the image 50 is displayed as the root screen 76 of the menu system by the touch sensitive device 70.

For example, as illustrated in FIG. 2F, the GUI 20 is configured to enable user definition of a second area 62 in the image 50. The GUI 20 is configured to recognize, in series, a user selection action that selects a point 64 in the image 50, a user movement action relative to the point 64, and a user de-selection action. The point 64 determines a location of the second area 62 and the user movement action until the user de-selection action determines a boundary 66 of the second area 62.

Referring to FIGS. 3A and 3B, the second area 62 becomes a second touch-sensitive area 74 of the root screen 76 of the menu system when the image 50 is displayed as the root screen 76 of the menu system on a touch-screen device 70.

In FIG. 3A, the second touch sensitive area 74 is not highlighted or demarcated in the image 50. In FIG. 3B, the second touch sensitive area 74 is highlighted 78 or otherwise demarcated in the image 50.

Referring back to FIG. 2F, as part of the process of defining the first area 52, the GUI 20 may also enable a user to define visual attributes of the second area 62, 74.

The GUI 20 is also configured to enable user definition of an association between the second area 62 in the image 50 and a user selected second asset. GUI 20 is configured to recognize, in series, a user selection action that selects the second area 62, a user movement action 63 between the second area 62 and the graphical representation 36 of the second asset B, and a user de-selection action at the graphical representation 36 of the second asset B. This series of actions creates an association between the second area 62 in the image 50 and a user selected second asset B.

The association between the second area 62 in the image 50 and the user selected second asset B is represented graphically by a visible second graphical link 44 between the image 50 (and subsequently the graphical representation 32 of the image 50) and the graphical representation 36 of second asset B.

Referring to FIGS. 3A and 3B, this association provides for the automatic use by the touch screen device 70 of the associated second asset B when the second touch-sensitive area 74 of the root screen 76 of the menu system is actuated while the image 50 is displayed as the root screen 76 of the menu system by the touch screen device 70.

Referring to FIG. 2G, the GUI 20 is configured to enable the image 50 to be reduced to the original graphical representation 32 of the image 50. In this Figure, the association between the first area in the image and the user selected first asset A is represented graphically by the first visible graphical link 42 between the graphical representation 32 of the image 50 and the graphical representation 34 of the first asset A. The association between the second area in the image and the user selected second asset is represented graphically by the second visible graphical link 44 between the graphical representation 32 of the image 50 and the graphical representation 36 of the second asset B.

The graphical representation 32 of the image 50 forms a root node of a directed acyclic rooted tree graph. The image asset 50 is associated with this root node. The graphical representation 34 of the first asset A forms a first node of the graph that depends from the root node. The first asset A is associated with this first node. The graphical representation 36 of the second asset B forms a second node of the graph that depends from the root node but does not depend from the first node. The second asset B is associated with this second node. The first graphical link 42 is a visible edge of the graph between the root node and the first node. The second graphical link 44 is a visible edge of the graph between the root node and the second node.

The graph defines the menu system in the touch-screen device 70. The menu is navigable by defining a single active node that represents the current menu state of the menu system. Navigating from one state of the menu system to another state of the menu system involves moving the allocation of the active node from a current node to another node directly interconnected by an edge to the current node. When a node becomes an active node, the asset associated with that node is automatically accessed and used.

The rooted graph has internal nodes that have one or more dependent nodes. The root node is a special case of an internal node as it does not depend from another node. The rooted graph has leaf nodes that depend from one or more internal nodes but that do not have dependent nodes.

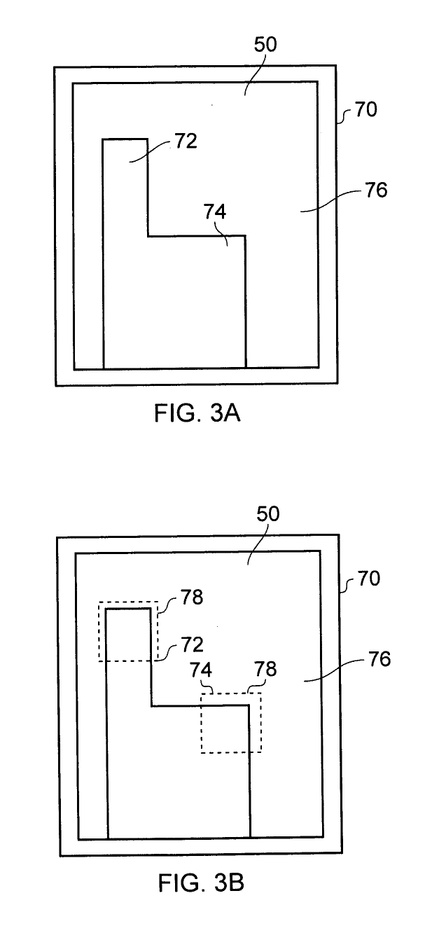

Referring to FIG. 5, the rooted graph may be defined using a collection of nodular data structures 94. The collection includes an internal-node data structure 102 for each internal node and a leaf-node data structure 104 for each leaf node.

Each internal-node data structure 102 comprises a definition 103 of an asset used when the internal node is the active node, a definition 104 of one or more user actuable widgets when the internal node is the active node and a definition 105 for each user actuable widget of an identifier identifying an associated nodular data structure. The definition 104 defines, for example, the touch-sensitive areas of an image as described above. In this case, the widget is a see-through touch sensitive button overlying the user-defined touch-sensitive area of the image. The definition 104 defines the asset used when the node associated with the data structure is active. In the case of the root node described above, the asset would be the image 50. The definitions 105 define the next possible nodes.

The touch-sensitive device initially provides the menu system by reading the internal-node data structure 102 representing the root node of the directed acyclic rooted tree graph.

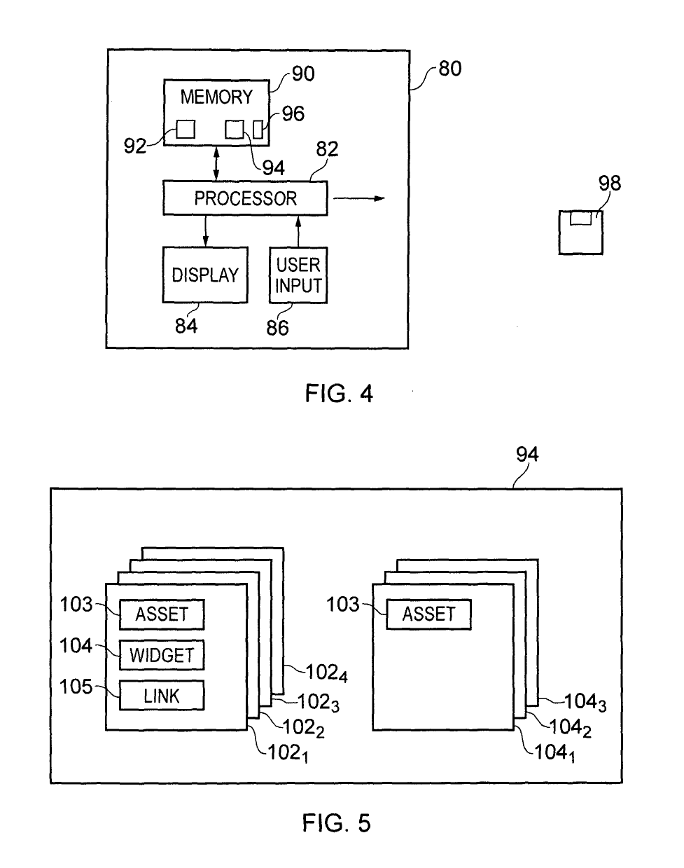

Below Extended Mark-up Language (XML) code is used to illustrate part of a suitable collection 94 of nodular data structures including internal—node data structures 102 and leaf-node data structures 104. The data structures define the directed acyclic rooted tree graph 110 illustrated in FIG. 6.

A node 112ₙₘ in the graph 110 is positioned at hierarchical level n (n=1, 2 . . . ) and at lateral index m (m=A, B, C . . . ). The root node 112_{1A} is separately connected to two dependent child nodes- a first node 112_{2A} and a second node 112₂₈ via respective edges 113_{2A}, 113_{2B}. The first node 112_{2A} is an internal node and is separately connected to dependent child nodes 112_{3A}, 112_{3B}, 112_{3C} via respective edges 113_{3A}, 113_{3B}, 113_{3C}. The second node 112_{2B} is a leaf node and is not connected to any dependent child nodes.

Each internal-node data structure 102 comprises an asset definition 103, widget(s) definition(s) and link definition(s) 105. The asset definition 103 defines the asset used when the node associated with the data structure is active. The widget definition 103 defines the user actuable widgets, such as the first area 52 and the second area 62 of the image 50 that define touch-sensitive areas 72, 74 of the root screen 76. A link definition 102 is associated with each user actuable widget and represents an edge in the graph 110. This link definition provides for the automatic change of the active node from the current node to the node linked by the link definition 105 associated with the user actuated widget.

In the menu system provided by this graph 110, the root node 112_{1A} has an associated internal-node data structure 102_{1A} referenced by its identifier “1A”.

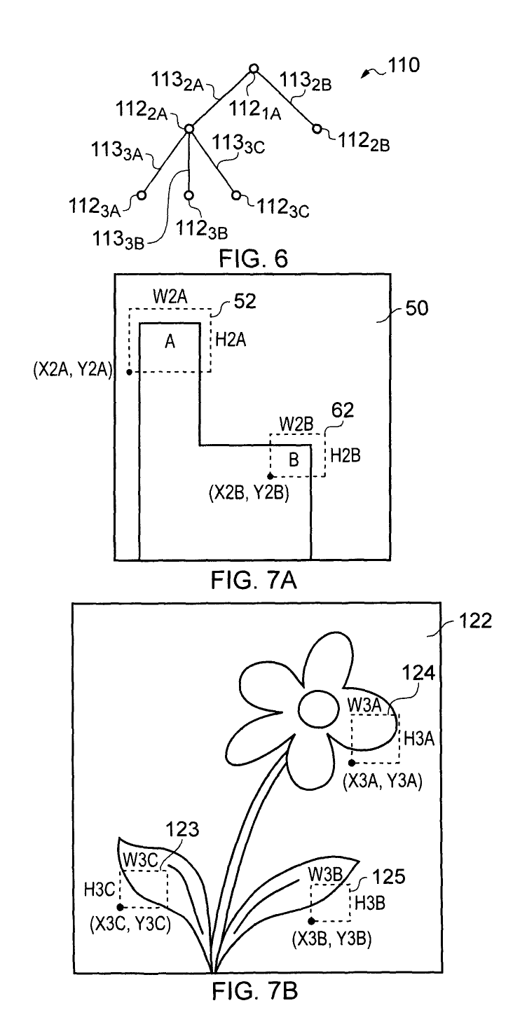

The internal-node data structure 102_{1A} comprises an asset definition 103 that defines the image 50 (FIG. 7A) using its identifier $$$.

A first widget definition 103 defines a first touch sensitive area 52 within the image 50. The first touch sensitive area 52 is defined in this example using an origin positioned using coordinates (X2A, Y2A) within an X-Y coordinate system of the image. In this example, the size and boundary of the area is defined using the dimensions of a rectangle having a fixed relationship to the origin. In this example, the origin is the bottom left corner of the rectangle and the rectangle is defined by its width (W2A) in the X-direction and its height (H2A) in the Y-direction. A first link definition 105 links to the internal-node data structure for node 112_{2A} in the graph 110 which is referenced using an identifier “2A” in this example. This link is activated when the first touch sensitive area 52 is activated by a user of the touch screen device 70 and, as a consequence, the linked data structure is automatically read.

A second widget definition 103 defines a second touch sensitive area 62 within the image 50. The second touch sensitive area 62 is defined in this example using an origin positioned using coordinates (X2B, Y2B) within an X-Y coordinate system of the image. The size and boundary of the area is defined using the dimensions of a rectangle having a fixed relationship to the origin. In this example, the origin is the bottom left corner of the rectangle and the rectangle is defined by its width (W2B) in the X-direction and its height (H2B) in the Y-direction. A second link definition 105 links to the leaf-node data structure for node 112₂₈ in the graph 110 which is referenced using an identifier “2B” in this example. This link is activated when the second touch sensitive area 62 is activated by a user of the touch screen device 70 and, as a consequence, the linked data structure is automatically read.

This is a suitable internal-node data structure 102_{1A}:

<node name=”1A” asset=”$$$”>

<event type=”touch” args=”A, Touch_A” action”jumpTo”
actionargs=”2A”>
<rect x=”X2A” y=”Y2A” w=”W2A” h=”H2A”/>
</event>
<event type=”touch” args=”B, Touch_B” action”jumpTo”
actionargs=”2B”>
<rect x=”X2B” y=”Y2B” w=”W2B” h=”H2B”/>
</event>

</node>

In this example, the node 112_{2A} has an associated internal-node data structure 102_{2A} referenced by its identifier “2A”. The internal-node data structure 102_{2A} comprises an asset definition 103 that defines an image 122 (FIG. 7B) using its identifier £££.

A first widget definition 103 defines a first touch sensitive area 124 within the image 122. The first touch sensitive area 124 is defined in this example using an origin positioned using coordinates (X3A, Y3A) within an X-Y coordinate system of the image. The size and boundary of the area is defined using the dimensions of a rectangle having a fixed relationship to the origin. In this example, the origin is the bottom left corner of the rectangle and the rectangle is defined by its width (W3A) in the X-direction and its height (H3A) in the Y-direction. A first link definition 105 links to the data structure for node 112_{3A} in the graph 110 which is referenced using an identifier “3A” in this example. This link is activated when the first touch sensitive area 124 is activated by a user of the touch screen device 70 and, as a consequence, the linked data structure is automatically read.

A second widget definition 103 defines a second touch sensitive area 125 within the image 122. The second touch sensitive area 125 is defined in this example using an origin positioned using coordinates (X3B, Y3B) within an X-Y coordinate system of the image. The size and boundary of the area is defined using the dimensions of a rectangle having a fixed relationship to the origin. In this example, the origin is the bottom left corner of the rectangle and the rectangle is defined by its width (W3B) in the X-direction and its height (H3B) in the Y-direction. A second link definition 105 links to the data structure for node 112₃₈ in the graph 110 which is referenced using an identifier “3B” in this example. This link is activated when the second touch sensitive area 125 is activated by a user of the touch screen device 70 and, as a consequence, the linked data structure is automatically read.

A third widget definition 103 defines a third touch sensitive area 123 within the image 122. The third touch sensitive area 123 is defined in this example using an origin positioned using coordinates (X3C, Y3C) within an X-Y coordinate system of the image. The size and boundary of the area is defined using the dimensions of a rectangle having a fixed relationship to the origin. In this example, the origin is the bottom left corner of the rectangle and the rectangle is defined by its width (W3C) in the X-direction and its height (H3C) in the Y-direction. A third link definition 105 links to the data structure for node 112_{3C} in the graph 110 which is referenced using an identifier “30” in this example. This link is activated when the second touch sensitive area 123 is activated by a user of the touch screen device 70 and, as a consequence, the linked data structure is automatically read.

This is a suitable internal-node data structure 102_{2A}:

<node name=”2A” asset=”£££”>

<event type=”touch” args=”A, Touch_A” action”jumpTo”
actionargs=”3A”>
<rect x=”X3A” y=”Y3A” w=”W3A” h=”H3A”/>
</event>
<event type=”touch” args=”B, Touch_B” action”jumpTo”
actionargs=”3B”>
<rect x=”X3B” y=”Y3B” w=”W3B” h=”H3B”/>
</event>
<event type=”touch” args=”C, Touch_C” action”jumpTo”
actionargs=”3C”>
<rect x=”X3C” y=”Y3C” w=”W3C” h=”H3C”/>
</event>

</node>

In this example, the node 112_{2B} has an associated leaf-node data structure 104_{2B} referenced by its identifier “2B” from the internal-node data structure 102_{1A}. The leaf-node data structure 104_{2B} comprises an asset definition 103 that defines an application or other executable file using its identifier “%%%”.

This is a suitable leaf-node data structure 104_{2B}:

<node name=“2B ” asset=“%%%”></node>

The menu system may be transported by exporting the collection 94 of nodular data structures defining the nodes and edges of a directed acyclic rooted tree graph 110. Some or all of the assets referenced by the nodular data structures may also be exported. For example, locally defined or created assets that may be unique or uncommon may be exported but shared assets such as standard applications may not be exported. A computer program that reads and plays the nodular data structures may also additionally be exported.

The menu system is loaded by reading the nodular data structure associated with the root node of the directed acyclic rooted tree graph.

Referring back to FIGS. 2A to 2G, although a storage area 24 is present in the illustrated embodiment, in other embodiments the storage area 24 may be absent. The graphical representation 32 of the image 50 and the graphical representations 34, 36 of the assets may then be dragged and dropped into the work area 22 directly without first being dragged and dropped into a storage area 24.

Referring back to FIGS. 2A to 2G, the GUI 20 is configured to enable user definition of an association between the first area 52 in the image 50 and the respective user selected asset B in addition to or as an alternative to the association between the additional area 62 in the image 50 and the respective user selected asset B. The association between the first area 52 in the image 50 and the respective user selected assets A and B provides for the automatic use of both the associated assets A and B when the respective touch-sensitive area 74 of the root screen 76 of the menu system is actuated while the image 50 is displayed as the root screen 76 of the menu system by the touch sensitive device 70. Thus, for example, selecting a touch sensitive area on a family photograph could launch a slideshow (first asset) related to the family or a member of the family and also play a music track (second asset).

The GUI 20 may also be configured to enable user definition of an association between an alternative defined user input such as a speech input or an input from a dedicated hardware key and one or more user selected assets. The association provides for the automatic use of the associated asset(s) when the respective defined user input is detected.

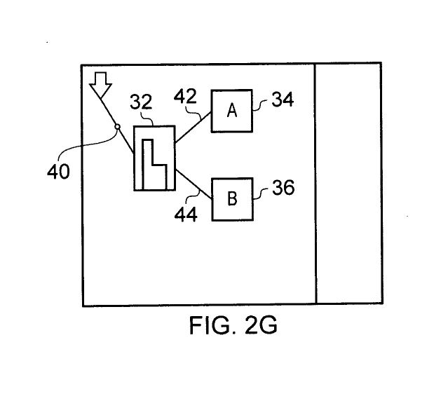

FIG. 4 schematically illustrates an apparatus 80 suitable for use in performing the method 10 described with reference to FIG. 1 and other Figures.

The apparatus 80 uses a controller to perform the method 10. Implementation of controller can be in hardware alone (a circuit, a processor . . . ), have certain aspects in software including firmware alone or can be a combination of hardware and software (including firmware).

The controller may be implemented using instructions that enable hardware functionality, for example, by using executable computer program instructions in a general-purpose or special-purpose processor that may be stored on a computer readable storage medium (disk, memory etc) to be executed by such a processor.

In the illustrated example, the controller is provided by at least one processor 82 and at least one memory 90 including computer program code 92, the at least one memory and the computer program code 92 configured to, with the at least one processor, cause the apparatus 80 at least to perform the method 10.

The processor 82 is configured to read from and write to the memory 90. The processor 90 may also comprise an output interface via which data and/or commands are output by the processor and an input interface via which data and/or commands are input to the processor 82.

The memory 90 stores a computer program 92 comprising computer program instructions that control the operation of the apparatus 80 when loaded into the processor 82. The computer program instructions 92 provide the logic and routines that enables the apparatus 80 to perform the method 10, for example, as illustrated in FIGS. 1 and 2A to 2G. The processor 82 by reading the memory 90 is able to load and execute the computer program 92.

The computer program instructions provide: computer readable program means for enabling user selection of an image for display as a root screen of a menu system; computer readable program means for enabling user definition of a first area in the image that becomes a first touch-sensitive area of the root screen of the menu system when the image is displayed as the root screen of the menu system; and computer readable program means for enabling user definition of an association between the first area in the image and a user selected first asset, wherein the association provides for the automatic use of the associated first asset when the first touch-sensitive area of the root screen of the menu system is actuated while the image is displayed as the root screen of the menu system.

The computer program may arrive at the apparatus 80 via any suitable delivery mechanism 98. The delivery mechanism 98 may be, for example, a computer-readable storage medium, a computer program product, a memory device, a record medium such as a CD-ROM or DVD, an article of manufacture that tangibly embodies the computer program 92. The delivery mechanism may be a signal configured to reliably transfer the computer program 92. The apparatus 80 may propagate or transmit the computer program 92 as a computer data signal.

Although the memory 90 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single /multi- processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memory 90 may also store the collection 94 of nodular data structures 102, 104 defining the nodes and edges of a directed acyclic rooted tree graph. A collection 96 of the assets referenced by the nodular data structures may also be stored in memory 90. A computer program that reads and plays the nodular data structures may also additionally be stored in memory 90.

The menu system may be loaded by apparatus 80 by reading the nodular data structure associated with the root node of the directed acyclic rooted tree graph.

The menu system may be transported by exporting the collection 94 of nodular data structures defining the nodes and edges of a directed acyclic rooted tree graph. Some or all of the assets 96 referenced by the nodular data structures may also be exported. For example, locally defined or created assets that may be unique or uncommon may be exported but shared assets such as standard applications may not be exported. A computer program that reads and plays the nodular data structures may also additionally be exported. The destination device may have a similar architecture with processor and memory as the apparatus 80. The destination device may, for example, be a touch-screen device 70. The menu system is loaded by reading the nodular data structure associated with the root node of the directed acyclic rooted tree graph from the memory and processing it using the processor.

It should be appreciated that the described method, GUI and apparatus enable the easy design of a menu system. They allow a designer to obtain quickly an appreciation of the ‘flow’ and ‘look and feel’ of a menu system.

The blocks illustrated in the FIG. 1 may represent steps in a method and/or sections of code in the computer program 92. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. A method comprising:
enabling user selection of an image for display as a root screen of a menu system;
enabling user definition, at an apparatus, of a first area in the image that becomes a first actuation-sensitive area of the root screen of the menu system when the image is displayed as the root screen of the menu system by providing at the apparatus a graphical user interface that recognizes a user selection action, a user movement action and a user de-selection action and enabling user definition of the first area by recognizing, in series, a user selection action that selects a point in the image, a user movement action relative to the point, and a user de-selection action, wherein the point determines a location of the first area and the user movement action until the user de-selection action determines a boundary of the first area; and
enabling user definition of an association between the first area in the image and a user selected first asset,
wherein the association provides for the automatic use of the associated first asset when the first actuation-sensitive area of the root screen of the menu system is actuated while the image is displayed as the root screen of the menu system.

2. (canceled)

3. (canceled)

4. A method as claimed in claim 1, further comprising enabling user definition of the visual attributes of the first area.

5. (canceled)

6. A method as claimed in claim 1, further comprising providing a graphical user interface that recognizes a user selection action, a user movement action and a user de-selection action and enabling user selection of the first asset by recognizing, in series, a user selection action that selects a graphical representation of the first asset, a user movement action that drags the graphical representation of the first asset, and a user de-selection action that drops the graphical representation of the first asset.

7. A method as claimed in claim 1, further comprising providing a graphical user interface that recognizes a user selection action, a user movement action and a user de-selection action and enabling user definition of an association between the first area in the image and a user selected first asset, by recognizing, in series, a user selection action that selects one of the first area or a graphical representation of the first asset, a user movement action between the first area and the graphical representation of the first asset, and a user de-selection action at the graphical representation of the first asset or at the first area.

8. A method as claimed in claim 7, wherein the association between the first area in the image and the user selected first asset is represented graphically by a visible graphical link between the first area in the image and the user selected first asset.

9. A method as claimed in claim 8, wherein the graphical link is a visible edge of a directed acyclic tree graph where the image is a root node and the first asset is a node depending from the root node.

10. A method as claimed in any preceding claim claim 1, further comprising providing a graphical user interface that recognizes a user selection action, a user movement action and a user de-selection action and enabling user selection of the image by recognizing, in series, a user selection action that selects a graphical representation of the image, a user movement action that drags the graphical representation of the image, and a user de-selection action that drops the graphical representation of the image.

11. A method as claimed in claim 1, further comprising:
enabling user definition of a second area in the image that becomes a second actuation-sensitive area of the root screen of the menu system when the image is displayed as the root screen of the menu system;
enabling user definition of an association between the second area in the image and a user selected second asset,
wherein the association provides for the automatic use of the associated second asset when the second actuation-sensitive area of the root screen of the menu system is actuated while the image is displayed as the root screen of the menu system.

12. A method as claimed in claim 7, wherein the association between the first area in the image and the user selected first asset is represented graphically by a visible first graphical link between the first area in the image and the user selected first asset and the association between the second area in the image and the user selected second asset is represented graphically by a second visible graphical link between the second area in the image and the user selected second, wherein the first graphical link is a visible edge of a directed acyclic tree graph where the image is a root node and the first asset is a first node depending from the root node and wherein the second graphical link is a visible edge of the directed acyclic tree graph where the second asset is a second node depending from the root node but not depending from the first node.

13. A method as claimed in claim 1, wherein the menu system is arranged as a directed acyclic tree graph comprising nodes and edges where the image is a root node, and the first asset is a node depending from the root node by an edge representing the association between the first area of the image and the first asset and wherein the menu is navigable by defining a single active node that represents the current menu state of the menu system and wherein navigating from one state of the menu system to another state of the menu system involves moving the allocation of the active node from a current node to another node directly interconnected by an edge to the current node, and wherein there is a nodular data structure for each internal node comprising: a definition of an asset used when the internal node is the active node, a definition of one or more user actuable widgets when the internal node is the active node and a definition for each user actuable widget of an identifier identifying an associated nodular data structure and wherein there is a nodular data structure for each leaf node comprising: a definition of an asset used when the leaf node is the active node.

14. A method as claimed in claim 13, wherein at least one nodular data structure for an internal node defines as an asset, an image, and defines one or more areas of the image as the one or more actuable widgets.

15. A method as claimed in claim 13, further comprising exporting the menu system by exporting: a plurality of nodular data structures defining the nodes and edges of a directed acyclic tree graph and at least some of the assets referenced by the plurality of nodular data structures

16. A method as claimed in claim 13, further comprising loading the menu system by reading a nodular data structure representing the root node of the directed acyclic tree graph.

17. (canceled)

18. (canceled)

19. An apparatus comprising:
at least one processor and at least one memory including computer program code the at least one memory and the computer program code configured to, with the at least one processor, cause the apparatus at least to perform: enabling user selection of an image for display as a root screen of a menu system;
enabling user definition of a first area in the image that becomes a first actuation-sensitive area of the root screen of the menu system when the image is displayed as the root screen of the menu system by providing a graphical user interface that recognizes a user selection action, a user movement action and a user de-selection action and enabling user definition of the first area by recognizing, in series, a user selection action that selects a point in the image, a user movement action relative to the point, and a user de-selection action, wherein the point determines a location of the first area and the user movement action until the user de-selection action determines a boundary of the first area;
enabling user definition of an association between the first area in the image and a user selected first asset,
wherein the association provides for the automatic use of the associated first asset when the first actuation-sensitive area of the root screen of the menu system is actuated while the image is displayed as the root screen of the menu system.

20. (canceled)

21. (canceled)

22. An apparatus comprising:
at least one processor and at least one memory including computer program code and a collection of data structures, the at least one memory and the computer program code configured to, with the at least one processor, cause the apparatus at least to provide a menu system arranged as a directed acycl is tree g raph comprising nodes and edges wherein the menu is navigable by defining a single active node that represents the current menu state of the menu system and wherein navigating from one state of the menu system to another state of the menu system involves moving the allocation of the active node from a current node to another node directly interconnected by an edge to the current node, wherein the collection of data structures comprises:
a nodular data structure for each internal node comprising:
a definition of an asset used when the internal node is the active node, a definition of one or more user actuable widgets when the internal node is the active node and a definition for each user actuable widget of an identifier identifying an associated nodular data structure; and
a nodular data structure for each leaf node comprising:
a definition of an asset used when the leaf node is the active node, wherein the apparatus initially provides the menu system by reading the nodular data structure representing the root node of the directed acyclic tree graph.

23. An apparatus as claimed in claim 22, wherein at least one nodular data structure for an internal node defines as an asset, an image, and defines one or more areas of the image as the one or more actuable widgets.

24. An apparatus as claimed in claim 22 configured to export the menu system by exporting: the collection of data structures defining the nodes and edges of a directed acyclic tree graph and at least some of the assets referenced by the plurality of nodular data structures
